(19) United States
(12) Patent Application Publication
(10) Pub. No.: US 2009/0192852 A1
(43) Pub. Date: Jul. 30, 2009

(54) METHOD OF TRACKING THE LIFECYCLE OF A PRODUCT

(75) Inventors: Jordon Lowell SOLLA, Bellevue, WA (US); Dale James BEARD, Seattle, WA (US)

Correspondence Address: DAVIS & BUJOLD, P.L.L.C., 112 PLEASANT STREET, CONCORD, NH, 03301, US

(73) Assignee: INTELLIWAVE TECHNOLOGIES INC., Edmonton (CA)

(21) Appl. No.: 12/362,079

(22) Filed: Jan. 29, 2009

Related U.S. Application Data
(60) Provisional application No. 61/024,215, filed on Jan. 29, 2008.

(51) Int. Cl. G06Q 10/00; G06Q 30/00

(52) U.S. Cl. 705/7; 705/28; 340/10.1

(57) ABSTRACT

A method of tracking a lifecycle of a product includes creating a template of a lifecycle of a product. The template includes steps in the lifecycle of the product between a supplier and a customer. The steps include steps of a manufacturing and delivery process. The template and the status of each step is stored in an electronic device that is accessible to the supplier and to the customer. The supplier accesses the template and modifies the status of each step in the manufacturing and delivery process as completed as the lifecycle progresses. The customer accesses the template to monitor the progress of the lifecycle.

### FIELD

A method of tracking the lifecycle of a product, such as between a supplier and a customer.

### BACKGROUND

For manufacturing businesses, it is very time consuming and expensive to create, update and view information about the properties and progress of a fabricated item. The current process to place orders for complex or custom designed products is to first submit a purchase order with engineered drawings and/or custom specifications to the manufacturer. The next step is for the manufacturer to respond with an estimated delivery date. The customer then applies that date to their project schedule. Through the entire process of manufacturing to shipment, the project timeline is based around the estimated delivery. Unless the manufacturer provides updates to the customer about the expected shipping date, the customer has no visibility of what is actually happening on a real-time basis, making it impossible to update project schedules with any accuracy on a timely basis. Due to lack of visibility with the current process, project schedules are modified at the last minute, making it difficult to reassign resources as necessary, thus creating an inefficient and costly process for the customer.

Fabricated products eventually arrive on the customer's site in a haphazard fashion, rarely on the date first given by the manufacturer. This scenario costs significantly more if the receiving end has not been informed ahead of time since they don't really know when to expect a shipment. With current information systems, the likelihood of efficiently using resources is non-existent since it is impossible to plan far ahead with any accuracy. However, if better visibility tools were available, then altering project schedules accordingly could alleviate this problem.

### SUMMARY

There is provided a method of tracking a lifecycle of a product. A template of a lifecycle of a product is created. The template comprises steps in the lifecycle of the product between a supplier and a customer. The steps comprise steps of a manufacturing and delivery process. The template and the status of each step is stored in an electronic device that is accessible to the supplier and to the customer. The supplier accesses the template and modifies the status of each step in the manufacturing and delivery process as completed as the lifecycle progresses. The customer accesses the template to monitor the progress of the lifecycle.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a diagram of a template with steps.

FIG. 2 is a flow chart of an example of the template being updated.

FIG. 3 is a block diagram depicting the movement of a product.

### DETAILED DESCRIPTION

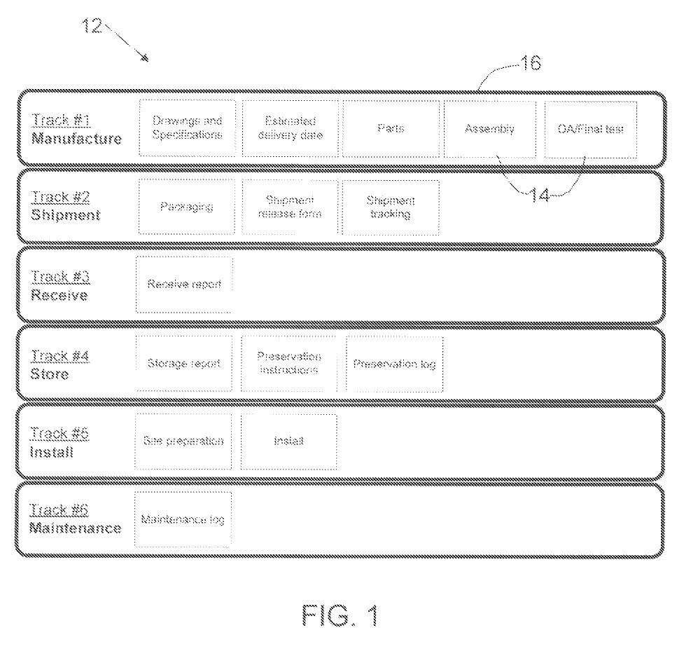

A method of tracking the lifecycle of a product will now be described with reference to FIG. 1 through 3.

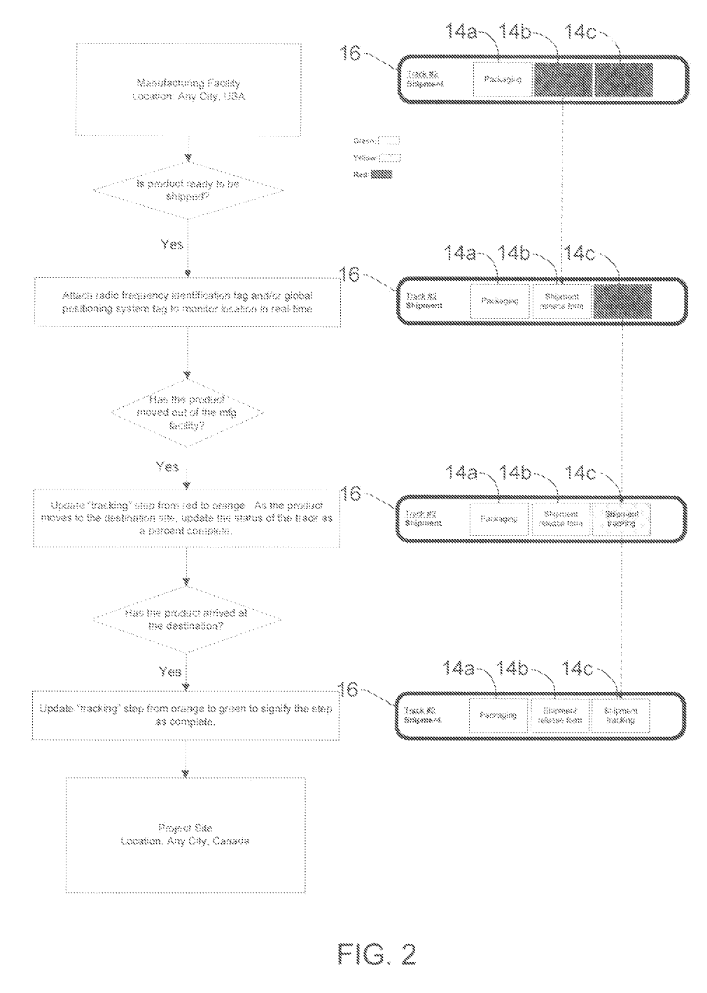

Referring to FIG. 1, the method of tracking the lifecycle of a product begins by creating a template, generally indicated by reference numeral 12. The product may be individual or bulk fabricated goods. Template 12 is made up steps 14 in the lifecycle of the product between a supplier and a customer, and is specific to the type product or application. In a preferred embodiment, related process steps 14 are grouped in tracks 16. Each step 14 or track 16 represents the steps of a manufacturing and delivery process, and may include any important milestones. As depicted, template 12 may also include steps beyond when a product is delivered to a customer, and may also include steps or tracks related to the installation or maintenance of the product. FIG. 2 shows how the status of the various tracks 16 and steps 14 are updated as a step is updated from incomplete (red), partially complete or in progress (yellow) and completed (green). As an example, FIG. 2 shows the modification of a track related to the shipping of a product. The shipment track 16 includes a packaging step 14a, a shipment release form step 14b, and a shipment tracking step 14c. At the beginning, packaging step 14a is colored green as having been complete, and steps 14b and 14c are colored red as not complete. Once the product is ready to be shipped, the shipment release form is completed, and the color of step 14b is changed from red to green. A position sensor may then be attached to the product, if not already done, and the product is then shipped. The color of step 14c is then changed from red to yellow, and once the product arrives at the intended destination, the color is changed from yellow to green.

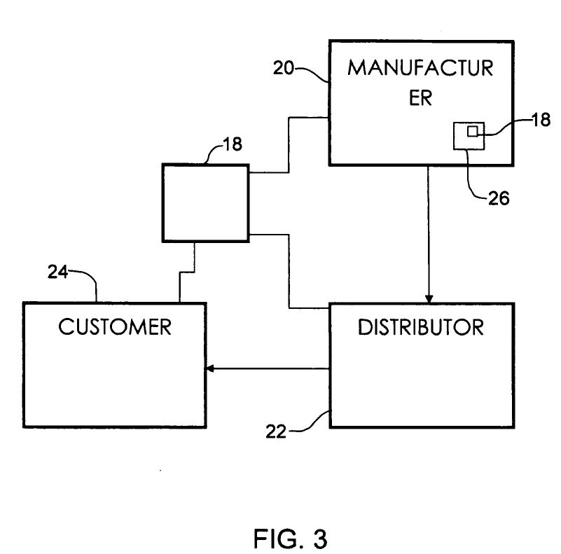

Referring to FIG. 3, template 12 is stored in an electronic device 18 that is accessible to both supplier, which may be a manufacturer 20, a distributor 22, or both, and customer 24, along with the status of each step 14 or track 16, as described above with reference to FIGS. 1 and 2. Preferably, template 12 is a graphical template, and the status of each step is communicated by its appearance. For example, a completed step or track may be coloured green, an incomplete step or track may be coloured red, and a step in progress may be coloured orange.

The supplier 20/22 is able to access template 12 to modify the status of each step 14 in the manufacturing and delivery process as completed as the lifecycle of the product 26 progresses. In a preferred embodiment, the status of at least one step is automatically modified by the supplier based on the physical location of the product as determined by an electronic monitoring device 28, such as a global positioning system (GPS), a radio frequency identification system (RFID), and electronic scanners. These electronic monitoring devices allow geo-fences, geo-locations or geo-paths to be associated with a specific track 16 or step 14.

Another electronic monitoring device may be the computer system used by the supplier, where an entry made by the supplier 20/22 may cause the status of the step or track to be updated automatically. Preferably, all of the steps 14 or tracks 16 would be updated automatically by electronic monitoring devices and systems.

The customer 24 is able to access the template to monitor the progress of the lifecycle. This allows the customer 24 to adjust the expectation of when the product will be delivered, and any schedules that depend upon this occurring. This may include an indication of the progress of the product relative to an estimated timeline. For example, the estimated timeline for the lifecycle of the product may have a predicted time for each step or tracks to be completed, along with an estimated delivery time to the customer. The estimated delivery time would be updated based on when the steps or tracks were actually completed. Algorithms may also be used to determine a products progress in a given track based on data relating the fabricated goods' time within a specific step, the characteristics of that step, the current progress track, and associated geo-location data.

Template 12 may also include manufacturing data for some or all steps 14 or tracks 16, such as material composition, specifications, fabrication properties or quality assurance data. This would be useful, for example, to allow the customer to catch any potential variations from what was originally ordered, or perhaps not specified when it is less difficult and expensive to fix.

### Advantages:

The process described above may also be referred to as “multi-track progressing”, which is a method for managing and graphing the entire lifecycle of a fabricated good from inception to end-of-life. A “track” may correspond to a discipline of construction, a necessary test, an alteration or a physical relocation of a good, among others. A track consists of steps or milestones that describe the individual action performed on the fabricated good. Each track, as well as a step or milestone, is associated with a geo-location, geo-fence or geo-path wherein a good's progress along the track can be derived from its location or the location can be derived based on its step within a track.

By using a multi-track progressing process to manage the data relating to a fabricated good, the customers' visibility problems can be efficiently overcome. As the product moves through each step of the various tracks, completed steps can be identified and updated automatically, thus giving the customer better visibility of the product's actual progress allowing for real-time corrections in project schedules and easier management of information about the fabricated goods.

Multi-track progressing allows each fabricated good to be assigned to a lifecycle template that contains progress tracks, steps and milestones for each step. The lifecycle template can be modified to match the lifecycle of any fabricated good. The complete lifecycle of a good can be viewed as a simple chart, as shown for example in FIG. 1, where each horizontal bar represents a different track. Information about the fabricated good, such as material composition, specifications, fabrication properties and quality assurance data may be stored with the progressing information as related to a particular step. One or many geo-fences, geo-locations or geo-paths are assigned to a progress track, step, milestone or any combination thereof.

Multi-track progressing, combined with positioning hardware such as Global Positioning Systems (GPS) or Radio Frequency Identification (RFID) real-time location systems, provide real-time location information (also known as geo-positioning). Based on the known geo-position, steps within a status track can be automatically updated to reflect whether or not a step has been completed.

In FIG. 1, a chart is shown for a product with 6 tracks. Each track is represented by a bar. As steps are completed, they turn from red to green, as described with reference to FIG. 2. If a step is partially complete, the color turns from red to orange. FIG. 2 shows the progress of a product that has been manufactured, and now is in the shipment track. The progress can be monitored as the release form is completed, the shipment tracking is marked orange for partially completed once the product is in transit. Once the product arrives at the customer site, the shipment tracking box will turn from orange to green. FIG. 2 also shows the link between the geo-location of the product to the completion of the step. By tying geo-location to the status of a particular step, steps can be automatically updated.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A method of tracking a lifecycle of a product, the method comprising the steps of:
creating a template of a lifecycle of a product, the template comprising steps in the lifecycle of the product between a supplier and a customer, the steps comprising steps of a manufacturing and delivery process;
storing the template and the status of each step in an electronic device that is accessible to the supplier and to the customer;
the supplier accessing the template and modifying the status of each step in the manufacturing and delivery process as completed as the lifecycle progresses;
the customer accessing the template to monitor the progress of the lifecycle.

2. The method of claim 1, wherein sequential steps are grouped in a track of related process steps.

3. The method of claim 1, wherein the template comprises an estimated timeline for the lifecycle of the product, the estimated timeline comprising a specified time for each step or a group of steps, such that the template indicates an estimated delivery time to the customer, and indicates the progress of the product relative to an estimated timeline.

4. The method of claim 3, further comprising using an algorithm to determine an estimated delivery time using the status of each step and predetermined characteristics of each step.

5. The method of claim 1, wherein the template is a graphical template, and the status of each step is communicated by its appearance.

6. The method of claim 1, wherein the status of at least one step is automatically modified by the supplier based on the physical location of the product as determined by an electronic monitoring device.

7. The method of claim 6, wherein the electronic monitoring device comprises at least one of: a global positioning system (GPS), a radio frequency identification system (RFID), and an electronic scanner.

8. The method of claim 1, wherein, for at least one step, the template contains manufacturing data comprising at least one of material composition, specifications, fabrication properties and quality assurance data for that step.
